(19) United States
(12) Patent Application Publication
(10) Pub. No.: US 2005/0268822 A1
(43) Pub. Date: Dec. 8, 2005

(54) Acid-resistant sulfur material and method for application of acid-resistant sulfur material

(75) Inventor: Hiroshi Hashimoto, Yokohama-shi (JP)

Correspondence Address: DARBY & DARBY P.C., P. O. BOX 5257, NEW YORK, NY, 10150-5257, US

(73) Assignee: NIPPON OIL CORPORATION, Tokyo (JP)

(21) Appl. No.: 10/522,441

(22) PCT Filed: Jul. 25, 2003
(86) PCT No.: PCT/JP03/09433

§ 371 Date: Mar. 16, 2005

(30) Foreign Application Priority Data
Jul. 31, 2002 (JP) 2002-223363

(51) Int. Cl. C04B 14/00; C04B 18/04

(52) U.S. Cl. 106/736; 106/483; 106/405; 106/481; 106/489; 106/486; 106/482; 106/737; 106/738

(57) ABSTRACT

The present invention provides an acid-resistant sulfur material that has excellent strength, and is capable of exhibiting excellent corrosion resistance and excellently maintaining appearance even in a strongly acidic environment, a high concentration hydrogen sulfide environment, or a high concentration sulfur-oxidizing bacterial environment. The invention also provides a method of constructing such an acid-resistant sulfur material. The acid-resistant sulfur material contains a modified sulfur and an aggregate, the modified sulfur having been prepared by polymerizing sulfur with a sulfur modifier. The aggregate is an inorganic aggregate containing at least Si, and a weight ratio of Ca, Si, and Al in the aggregate in terms of oxides expressed as CaO/(SiO₂+Al₂O₃) is not higher than 0.2.

### FIELD OF ART

The present invention relates to acid-resistant sulfur materials that may be used as materials for civil engineering or construction products utilizing sulfur, and that have excellent acid resistance, and to a method of constructing such sulfur materials.

### BACKGROUND ART

In acid soil areas such as hot-spring areas, concrete materials, such as Hume pipes, tend to be eroded by the action of sulfate or sulfite ions in the acid soil. Concrete materials for sewerage are eroded in a short time in the areas where sulfuric acid is generated in sewage by the action of organic substances and bacteria, and prematurely require repairing or renewal.

In such environments requiring acid resistance, plastic materials such as polymers produced by mixing and molding polyvinyl chloride or unsaturated polyester with aggregates, are used for constructing sewer pipes and the like. However, plastic materials are expensive, hard to be made into large products, and unusable in hot soils such as in hot-spring areas.

Antimicrobial concrete Hume pipes are in production, which inhibit propagation of sewage bacteria on the pipe surface. However, such Hume pipes are capable of inhibiting propagation of bacteria only on the pipe surface, and are not made of an acid resistant material, so that these Hume pipes tend to be eroded when brought into contact with acid.

Acid-resistant materials are disclosed, for example, in JP-2000-72523-A, which proposes sulfur concrete products produced by consolidating sulfur and mineral powders. These consolidated sulfur concrete products have usually about one-third the strength of, and at most slightly poorer strength than, concrete containing cement, and are not satisfactory in strength as civil engineering or construction stock materials. Still less, these sulfur concrete products do not have sufficient acid resistance to survive the environment of not higher than pH 3.5.

JP-2001-253759-A discloses a sulfur composition containing sulfur and granulated coal ash coated with cement for producing molded products having excellent strength and acid resistance. The cement and coal ash contribute to maintenance of the strength of the produced molded products initially after construction, and the sulfur gives some acid resistance. However, the crystal structure of sulfur changes with the lapse of time to cause shrinkage of the molded products, sometimes accompanied by cracks. Poor acid resistance of cement allows acid corrosion to proceed from the cracks to lower the strength of the products. Thus these products can hardly be used as actual civil engineering or construction stock materials for use in acid soils or sewage, which require certain acid resistance.

### SUMMARY OF THE INVENTION

It is an object of the present invention to provide an acid-resistant sulfur material that may be used for producing civil engineering or construction products for use in acid soil areas or sewerage, that may be made into molded products having the same or higher strength than that of conventional concrete products containing cement, and that is capable of exhibiting superior corrosion resistance and excellently maintaining its appearance even in a strongly acidic environment, a high concentration hydrogen sulfide environment, or a high concentration sulfur-oxidizing bacterial environment.

It is another object of the present invention to provide a method of constructing an acid-resistant sulfur material wherein the sulfur material is constructed in an environment of not higher than pH 3.5, with superior strength, corrosion resistance, and appearance being maintained.

According to the present invention, there is provided an acid-resistant sulfur material comprising a modified sulfur and an aggregate, said modified sulfur having been prepared by polymerizing sulfur with a sulfur modifier,
wherein said aggregate is an inorganic aggregate comprising at least Si, or at least Ca and Si, and
wherein a weight ratio of Ca, Si, and Al in the aggregate in terms of oxides expressed as CaO/(SiO₂+Al₂O₃) is not higher than 0.2.

According to the present invention, there is also provided a method of constructing an acid-resistant sulfur material comprising the steps of:
producing a civil engineering or construction product with the above-mentioned acid-resistant sulfur material, and
placing said product in an environment of not higher than pH 3.5.

### BRIEF DESCRIPTION OF THE DRAWINGS

FIG. 1 is a schematic view of a production system for producing a material containing a modified sulfur used in Example 3.

FIG. 2 shows photocopies of photographs showing the appearance of specimens prepared in Examples 1 to 3 and Comparative Examples 1 and 2 after the test of resistance to an aqueous solution of acid (sulfuric acid).

FIG. 3 shows photocopies of photographs showing the appearance of specimens prepared in Examples 1 to 3 and Comparative Examples 1 and 2 after the test of resistance to an aqueous solution of acid (hydrochloric acid).

FIG. 4 shows photocopies of photographs showing the appearance of specimens prepared in Examples 1 to 3 and Comparative Example 1 after the test of resistance to sulfur-oxidizing bacteria.

FIG. 5 shows photocopies of photographs showing the appearance of specimens prepared in Examples 1 to 3 and Comparative Example 1 after the evaluation of accelerated concrete corrosion.

### PREFERRED EMBODIMENTS OF THE INVENTION

The present invention will now be explained in detail.

The acid-resistant sulfur material according to the present invention contains a modified sulfur obtained by polymerizing sulfur with a sulfur modifier, and a particular aggregate, and is substantially free of cement.

The sulfur for preparing the modified sulfur is an ordinary, elemental sulfur, and may be natural sulfur or sulfur generated by desulfurization of oil or natural gas.

The sulfur modifier for preparing the modified sulfur may be, for example, dicyclopentadiene (DCPD), tetrahydroindene (THI), or one or more compounds selected from the group consisting of olefin compounds such as cyclopentadiene, oligomers thereof (mixtures of dimers to pentamers), dipentene, vinyl toluene, and dicyclopentene.

As used herein, “DCPD” means DCPD alone, or a mixture mainly composed of cyclopentadiene and a dimer to pentamer thereof. The mixture has a DCPD content of not lower than 70 mass %, preferably not lower than 85 mass %. Thus most of the commercially available products referred to as dicyclopentadiene may be used.

As used herein, “THI” means THI alone, or a mixture of THI and a material mainly composed of one or more members selected from the group consisting of cyclopentadiene, polymers of cyclopentadiene, polymers of butanediene, and a dimer to pentamer of cyclopentadiene. The mixture has a THI content of usually not lower than 50 mass %, preferably not lower than 65 mass %. Thus most of the commercially available products referred to as tetrahydroindene, and by-product oils discharged from ethylnorbornene production plants may be used as THI in the present invention.

The amount of the sulfur modifier used in preparation of the modified sulfur is preferably 0.01 to 30 parts by weight, more preferably 0.1 to 20 parts by weight, based on 100 parts by weight of sulfur.

The modified sulfur may be prepared, for example, by mixing sulfur and the sulfur modifier in molten states to polymerize the sulfur. The mixing in molten states may be carried out, for example, in an internal mixer, roll mill, drum mixer, pony mixer, ribbon mixer, homo mixer, or static mixer, with a line mixer such as a static mixer being particularly preferred. The line mixer allows production of homogeneous modified sulfur, improves productivity of the modified sulfur, and provides sufficient modification of sulfur even with a small amount of the sulfur modifier. Further, the line mixer inhibits evaporation loss of the sulfur modifier caused by heat from the molten sulfur, so that even as small as 0.1 to 10 parts by weight of the sulfur modifier based on 100 parts by weight of sulfur, gives the objective modified sulfur.

The amount of the sulfur modifier used in preparing the modified sulfur is one of the factors for improving properties of the acid-resistant sulfur material of the present invention, such as fire-resistance, water sealability, and resistance to sulfur-oxidizing bacteria. The more sulfur modifier is used, the more these properties are improved. However, at about 30 parts by weight of the sulfur modifier to 100 parts by weight of sulfur, the improvement in these properties by the modified sulfur reaches the maximum, and further increase in the amount will not result in much change. On the other hand, less than 0.01 parts by weight of the sulfur modifier hardly gives sufficient strength to the resulting molded product.

The modified sulfur may be prepared, for example, by mixing sulfur and the sulfur modifier in molten states at 120 to 160° C. in a mixer such as a line mixer, and retaining the mixture until its viscosity at 140° C. falls in the range of 0.05 to 3.0 Pa·s. The temperature in the line mixer for melting and mixing is preferably 130 to 155° C., more preferably 140 to 155° C., for achieving effective modification of sulfur.

The initial reaction between sulfur and the sulfur modifier occurred in the line mixer is an exothermic reaction to generate a precursor of modified sulfur through the reaction between sulfur and the sulfur modifier. Thus under the observation that no sudden temperature rise occurs in the line mixer, sulfur and the sulfur modifier are continuously stirred in the line mixer to gradually increase the temperature to 120 to 160° C.

In reacting sulfur and the sulfur modifier in the line mixer, a precursor of modified sulfur is generated having a molecular weight of 150 to 500 as measured by gel permeation chromatography (GPC), and usually 0.01 to 45 wt %, preferably 1 to 40 wt % of the precursor of modified sulfur is generated in the reaction system.

The molecular weight of the precursor may be measured by GPC using the sulfur mixed with the sulfur modifier dissolved in carbon disulfide or toluene. For example, the molecular weight may be measured by GPC using a sample solution containing 1 mass/vol % carbon disulfide at a flow rate of 1 ml/min at room temperature, with chloroform as an eluent and a UV detector at 254 nm, and determined against a calibration curve obtained from polystyrene standard.

The line mixer may be a static mixer. Generally, a static mixer has baffles arranged in a fluid flow passage such as a pipe, and mixes fluids by splitting flows of the fluids with the baffles to change their streamlines. The static mixer used in preparation of the modified sulfur has preferably one or more, more preferably 4 to 32 twisted vane elements arranged in the pipe.

The flow rate and the pressure in the line mixer may suitably be decided depending on the diameter of the pipe or the amount of the product, and the preferred flow rate is about 0.1 to 100 cm/sec. The treatment time in the line mixer is usually about 1 second to 30 minutes. After the reaction between sulfur and the sulfur modifier starts to generate the precursor of modified sulfur, the sulfur modifier no longer evaporates, so that the line mixer may not be used after the commencement of the reaction. Further, the reaction product containing sulfur and the precursor of modified sulfur discharged from the line mixer may be introduced into and retained in a holding tube to polymerize the precursor of modified sulfur and the molten sulfur for increasing the molecular weight of the product. The holding tube preferably has static mixer elements therein.

The residence time in the holding tube may suitably be decided depending on the diameter of the tube or the amount of the product, and may preferably be for about 1 minutes to about 1 hour. The residence time may also vary depending on the amount of the sulfur modifier or the temperature for melting.

When to terminate the reaction for sulfur modification may be decided taking the viscosity of the melt into account. For example, the reaction may preferably be terminated when the viscosity of the melt at 140° C. falls in the range of 0.05 to 3.0 Pa·s. In view of the strength of the resulting product molded from the modified sulfur and the workability during its production process, it is comprehensively most preferred to terminate the reaction when the viscosity at 140° C. falls in the range of 0.05 to 2.0 Pa·s.

When the viscosity is less than 0.05 Pa·s, the strength of the civil engineering or construction products obtained from the modified sulfur is too low, and the modifying effect of the sulfur modifier is not sufficiently expressed. With the increase in the viscosity, the modification proceeds, and the strength of the resulting modified sulfur also increases. However, with the viscosity exceeding 30 Pa·s, the modified sulfur is hard to be molded, and the workability is significantly impaired, thus not being preferred.

The line mixer allows easy control of the molecular weight distribution of the resulting modified sulfur to fall within the range of usually 200 to 3000, preferably 200 to 2500, and provides a narrower molecular weight distribution than a batch mixer, with the average molecular weight being maintained at a comparable level (350 to 550).

The modified sulfur in the acid-resistant sulfur material of the present invention is a sulfur polymerized and modified through the reaction of sulfur and the sulfur modifier, and may contain pure sulfur. By combining this modified sulfur with the particular aggregate of the present invention, civil engineering or construction products of excellent acid resistance and strength capable of surviving the environment of not higher than pH 3.5 may be obtained, which environment cannot be survived by conventional civil engineering or construction products made of, for example, concrete containing cement.

The aggregate used in the acid-resistant sulfur material of the present invention contains at least Si, or at least Ca and Si, and optionally Al. The aggregate is an inorganic aggregate wherein a weight ratio of Ca, Si, and Al in terms of oxides expressed as CaO/(SiO₂+Al₂O₃) is not higher than 0.2, in other words, 0 to 0.2, and when the aggregate contains at least Ca and Si, the weight ratio expressed as CaO/(SiO₂+Al₂O₃) is preferably 0.01 to 0.2, more preferably 0.1 to 0.2. Such inorganic aggregate may be one or more kinds of aggregates mainly composed of silica components, such as coal ash, silica sand, silica, quartz powders, quartz rocks, gravel, sand, clay minerals, and glass powders. When the CaO/(SiO₂+Al₂O₃) weight ratio of the aggregate exceeds 0.2, desired acid resistance cannot be achieved. Thus, blast furnace slag, incinerated ash, and the like having a CaO/(SiO₂+Al₂O₃) weight ratio exceeding 0.2 are substantially not usable in the acid-resistant sulfur material of the present invention. The weight ratio of Ca, Si, and Al in the aggregate is determined by calculating the Ca, Si, and Al contents in terms of CaO, SiO₂, and Al₂O₃, respectively. The aggregate may not contain Ca or Al, which are optional components.

The coal ash may be conventional coal ash discharged from various coal combustion furnaces such as those for power generation or for heating, and may be, for example, fly ash, clinker ash, or bottom ash.

The inorganic aggregate preferably contains not less than 5 wt %, preferably 5 to 50 wt % of an aggregate having an average particle size of not larger than 100 μm, in order to further increase the mechanical strength of the various civil engineering or construction products made with the acid-resistant sulfur material of the present invention. Examples of such aggregate include fly ash and silica sand, both of which may be used in the present invention, with fly ash being particularly preferred. Here, the average particle size is determined by laser diffraction.

The acid-resistant sulfur material of the present invention may optionally contain other aggregates free of Ca and/or Si, as long as the effects of the present invention are not impaired.

In the acid-resistant sulfur material of the present invention, the mixing ratio of the modified sulfur and the aggregate is usually 1 to 5:9 to 5 by weight. It is most preferred that the modified sulfur is in such an amount as to fill the gaps in the aggregate consolidated to the maximum density. At such a ratio, the maximum strength of the sulfur material is achieved. When the amount of the modified sulfur is less than 10 wt %, or the amount of the aggregate is more than 90 wt %, the surface of the inorganic material as the aggregate cannot be wet sufficiently and is left exposed, resulting in insufficient expression of the strength and incapability of maintaining the water sealability. When the amount of the modified sulfur is more than 50 wt %, or the amount of the aggregate is less than 50 wt %, the properties of the resulting sulfur material are similar to those of the modified sulfur alone, and the strength may not be high enough.

The mixing ratio of the modified sulfur and the aggregate may also vary depending on the kind of aggregate or the kind of civil engineering or construction products to be produced. It is thus desirable to suitably select the mixing ratio from the above-mentioned range, taking these factors into account.

In addition to the above-mentioned modified sulfur and the particular aggregate, the acid-resistant sulfur material of the present invention may optionally contain a fiber filling in order to further improve the bending strength required depending on the kind of civil engineering or construction products to be produced. Specifically, by adding a fiber filling to the acid-resistant sulfur material of the present invention in preparing civil engineering or construction products such as panels or tiles, the resulting products may be made thinner or lighter.

Examples of the fiber filling may include carbon fibers, glass fibers, steel fibers, amorphous fibers, vinylon fibers, polypropylene fibers, polyethylene fibers, aramid fibers, and mixtures of two or more of these.

A preferred diameter of the fiber filling is usually 5 μm to 1 mm, which may vary depending on its material. The fiber filling may either be short or continuous fibers, and the length of the short fibers is preferably 2 to 30 mm for allowing uniform dispersion. The continuous fibers may preferably be a lattice material having mesh that allow passage of the aggregate, and such lattice material may have either a woven or non-woven fabric structure.

The content of the fiber filling may usually be 0.5 to 10 vol %, preferably 1 to 7 vol % of the acid-resistant sulfur material.

The acid-resistant sulfur material of the present invention may further contain fibrous particles and/or flake particles, in order to improve the toughness of the civil engineering or construction products to be produced.

Examples of the fibrous particles may include wollastonite, bauxite, and mullite, each having an average length of not longer than 1 mm. Examples of the flake particles may include mica flakes, talc flakes, vermiculite flakes, and alumina flakes, each having an average particle size of not larger than 1 mm.

The content of the fibrous particles and/or flake particles is usually not higher than 35 wt %, preferably 10 to 25 wt % of the total amount of the acid-resistant sulfur material.

The acid-resistant sulfur material of the present invention may be prepared, for example, by mixing the modified sulfur in a molten state, the aggregate, and optionally other materials, and cooling. The modified sulfur may be melted upon mixing with the aggregate, or may be kept in a molten state in advance of mixing with the aggregate in a storage container such as a storage tank capable of storage at 120 to 140° C., and mixed in a molten state with the aggregate. By keeping the modified sulfur in such a storage container, and using a desired amount as required, continuous production may be effected, rather than batch production.

The modified sulfur in a molten state, the aggregate, and optionally other materials may be mixed usually at 120 to 160° C., preferably at 130 to 140° C., usually for 5 to 30 minutes, while the viscosity of the modified sulfur at 140° C. is maintained in the range of 0.05 to 3.0 Pa·s. After the mixing, the resulting mixture is cooled down to not higher than 120° C., to thereby providing a desired acid-resistant sulfur material.

The viscosity of the modified sulfur during the mixing in a molten state should be kept in a preferred optimum viscosity range that allows easy handling, since the viscosity increases as the polymerization of sulfur proceeds with the lapse of time. The preferred viscosity range for the modified sulfur is 0.05 to 3.0 Pa·s at 140° C. If the viscosity is less than 0.05 Pa·s, the strength of the resulting sulfur material tends to be too low. The higher the viscosity is, the higher the strength of the resulting material is. However, if the viscosity is higher than 3.0 Pa·s, the stirring operation in the production process becomes hard, and the workability is remarkably deteriorated, thus not being preferred.

Before the mixing operation, it is preferred to pre-heat the aggregate to about 120 to 155° C., and the mixer to 120 to 155° C., in order to avoid temperature drop in the mixing.

The duration of the mixing in a molten state is preferably as short as possible as long as the properties of the resulting product permit, for avoiding too high a viscosity or curing of the mixture due to the polymerization of sulfur and the sulfur modifier. However, if the duration of mixing is too short, the modified sulfur and the aggregate are not mixed sufficiently, so that the resulting material will not be given a continuous phase and will have gaps and a rough surface. With sufficient mixing, the resulting material will be given a perfectly continuous phase with smooth surface. Thus the duration of mixing must be decided suitably depending on the properties of the acid-resistant sulfur material to be obtained.

The mixer to be used in the mixing is not particularly limited as long as thorough mixing is provided, and may preferably be a solid-liquid mixer such as an internal mixer, roll mill, ball mill, drum mixer, screw extruder, pug mill, pony mixer, ribbon mixer, or kneader.

After the mixing in a molten state, the resulting mixture is cold molded into an acid-resistant sulfur material of the present invention in accordance with a known method, depending on the kind of products to be produced, such as civil engineering or construction products. The cold molding may be carried out by pouring the mixture into a mold, cooling, and solidifying into a desired shape. For molding tubular products, such as Hume pipes and manholes, centrifugal casting may be employed. For molding box culverts, panels, tiles, and blocks, the mixture may be poured into a mold and vibration molded. The molding may be performed under suitable vibration or with irradiation with ultrasonic wave for consolidation.

The acid-resistant sulfur materials of the present invention may be placed in various locations. For making use of their excellent acid-resistance, the present acid-resistant sulfur materials are preferably placed in accordance with the following construction method of the present invention.

The method of constructing the acid-resistant sulfur material of the present invention includes the steps of producing a civil engineering or construction product with the above-mentioned acid-resistant sulfur material, and placing the product in an environment of not higher than pH 3.5.

Examples of the civil engineering or construction products may include Hume pipes, box culverts, manholes, tiles, blocks, panels, flooring materials, and wall materials, and the panels may also be used as repair panels for sewerage. As road products, U-shaped gutters, side ditches, curb blocks, L-shaped blocks, plates, and interlocking blocks are included. As building products, building blocks, piles, Hume pipes, fish reefs, wave dissipating blocks, and breakwater blocks are included. As civil engineering materials, earth retaining walls, retaining walls, L-shaped retaining walls, and sheet piles are included.

The acid-resistant sulfur material does not have to be used all over the civil engineering or construction products, but may be used only in parts which are brought into contact with acid for achieving the objects of the present invention. For example, a Hume pipe may be lined on its inner surface with the acid-resistant sulfur material, and have a concrete outer wall. Similarly in other usage, such as in box culverts, manholes, tiles, blocks, panels, flooring materials, and wall materials, the acid-resistant sulfur material may be combined with concrete to provide a double-layered structure, or even a triple-layered structure with the acid-resistant sulfur materials arranged on both sides of concrete.

The environment in which the civil engineering or construction products are to be placed may be any environment as long as the pH of the environment could be not higher than pH 3.5, and may include sewage treatment facilities, wherein pH is of such value, and acidic hot-spring facilities, wherein pH could be 1.5 or lower.

Since the acid-resistant sulfur material according to the present invention contains the modified sulfur and the particular aggregate, the material exhibits excellent corrosion resistance, strength, durability, and capability of maintaining appearance, even in a strongly acidic environment, a high concentration hydrogen sulfide environment, or a high concentration sulfur-oxidizing bacterial environment. Thus the present sulfur material is particularly useful for producing civil engineering or construction products for use in acid soils and sewerage. Further, since the method of construction according to the present invention employs the above-mentioned acid-resistant sulfur material, Hume pipes, box culverts, manholes, tiles, blocks, panels, and the like structures may be constructed with expected long-term durability, even in the environment of not higher than pH 3.5.

### EXAMPLES

The present invention will now be explained with reference to Examples and Comparative Examples, but the present invention is not limited to these. Each molded product prepared in Examples and Comparative Examples was measured and evaluated in accordance with the following methods.

Evaluation of Resistance to Aqueous Solution of Acid

Each specimen prepared in Examples and Comparative Examples was soaked at room temperature in a 10 wt % sulfuric acid aqueous solution or a 10 wt % hydrochloric acid aqueous solution for six months, and taken out to evaluate the degree of degradation. As the indices of degradation, change of the appearance, weight change calculated from the weight measured after the moisture on the specimen surface was wiped off, and strength loss calculated from the compressive strength measured, were compared. The strength loss was determined by measuring the compressive strength of each specimen after the test using TENSILON compressive strength measuring equipment at the pressure of 30 tons, and comparing the measured value with the referential compressive strength measured on the seventh day after the preparation of the specimen measured in the same manner.

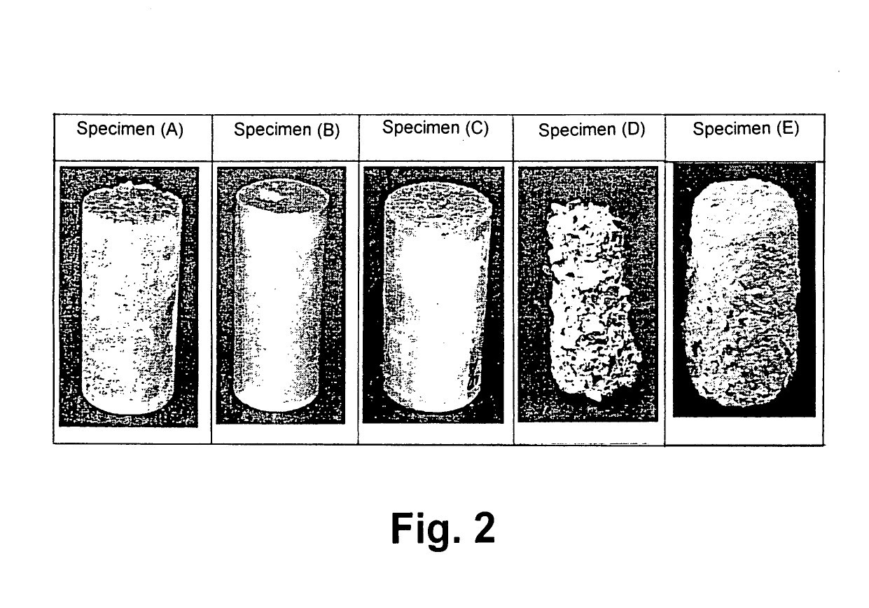

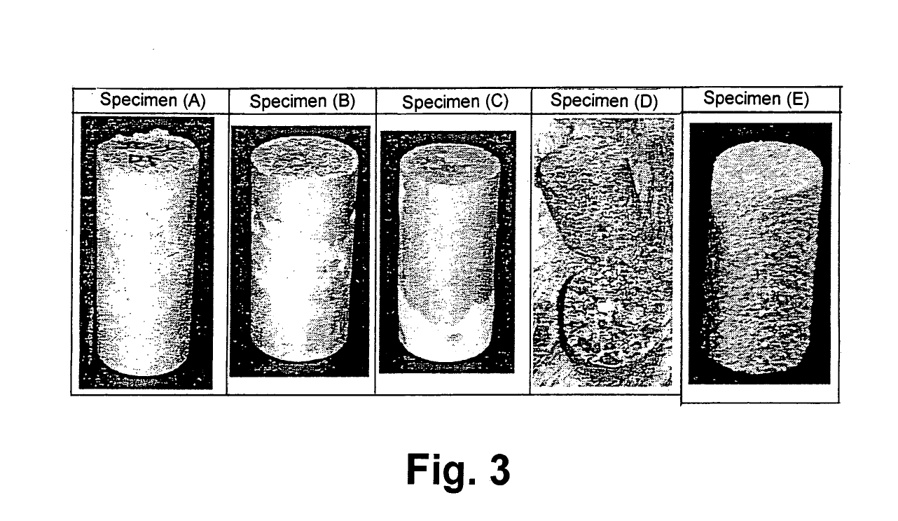

The results of the test using the aqueous solution of sulfuric acid for soaking are shown in Table 1, and the corresponding photographs showing the appearance of the specimens (A) to (E) are shown in FIG. 2. The results of the test using the aqueous solution of hydrochloric acid for soaking are shown in Table 2, and the corresponding photographs showing the appearance of the specimens (A) to (E) are shown in FIG. 3.

Evaluation of Resistance to Sulfur-Oxidizing Bacteria

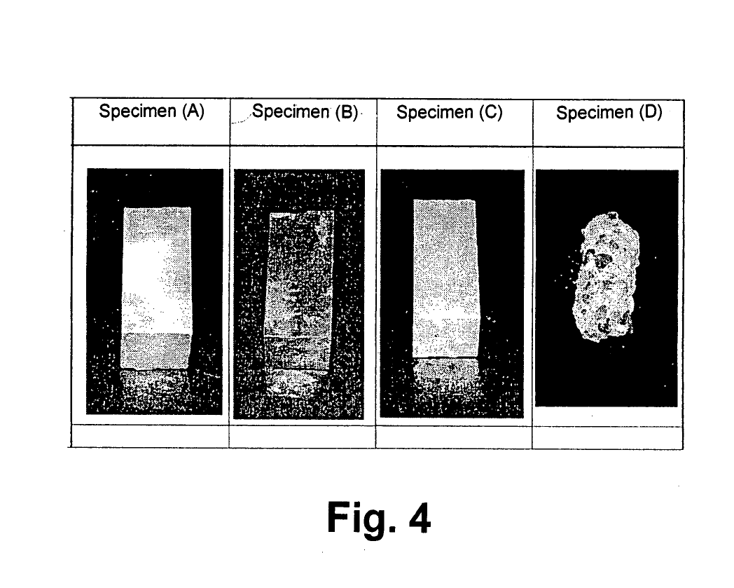

A specimen in the form of a 2 cm×2 cm×4 cm prism and 100 ml of a culture solution (2.0 g of NH₄Cl, 4.0 g of KH₂PO₄, 0.3 g of MgCl₂.6H₂O, 0.3 g of CaCl₂.2H₂O, 0.01 g of FeCl₂.4H₂O, and 1.0 liter of ion exchange water, adjusted to pH 3.0 with hydrochloric acid) were placed in a 500 ml baffled (ribbed) flask, inoculated with a starter (sulfur-oxidizing bacteria, Thiobacillus thiooxidans IFO 12544) and subjected to bacterial culture with rolling and shaking (170 rpm) in a thermostatic chamber at 28° C. Four months after the inoculation, the weight change and the appearance of each specimen prepared in Examples and Comparative Examples were determined. When sulfur is consumed by the sulfur-oxidizing bacteria, sulfate ions are generated, and the weight of a specimen decreases. The results are shown in Table 3, and photocopies of the photographs showing the appearance of specimens (A) to (D) are shown in FIG. 4.

Evaluation of Accelerated Concrete Corrosion

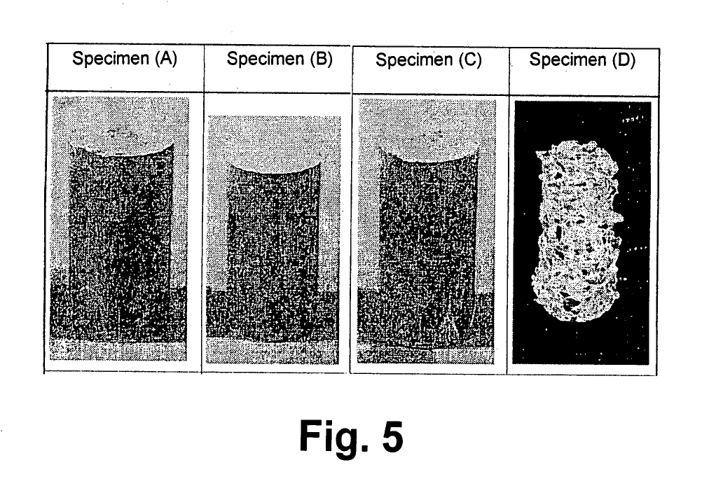

Each specimen prepared in Examples and Comparative Examples except for Comparative Example 2 was placed in a thermostatic chamber maintained at the humidity of not lower than 95%, the temperature of 30° C., and the hydrogen sulfide concentration of 200 ppm by weight, for 12 months, and evaluated for corrosion. As the indices of degradation, change of the appearance, weight change calculated from the weight measured after the moisture on the specimen surface was wiped off, and strength loss calculated from the compressive strength measured, each of after the twenty-month test, were compared. The strength loss was determined by measuring the compressive strength of each specimen after the test using TENSILON compressive strength measuring equipment at the pressure of 30 tons, and comparing the measured value with the referential compressive strength measured on the seventh day after the preparation of the specimen measured in the same manner. The results are shown in Table 4, and photocopies of the photographs showing the appearance of the specimens (A) to (D) are shown in FIG. 5.

### Example 1

950 g of solid sulfur was placed in a hermetically sealed internal mixer, heated at 120° C. to melt, and maintained at 130° C. Then 50 g of dicyclopentadiene previously heated to about 50° C. to melt was added slowly, and softly stirred for about 10 minutes. After the temperature rise due to the initial reaction was confirmed to converge, the reaction mass was heated to 150° C. The reaction was started, and the viscosity gradually rose. When the viscosity reached 0.1 Pa·s in about 1 hour, the heating was immediately terminated, and the resulting material was poured into a suitable mold or a container, and cooled at room temperature, to thereby obtain modified sulfur (A).

Next, an aggregate pre-heated to 140° C. consisting of 100 g of coal ash having an average particle size of 50 μm and the CaO/(SiO₂+Al₂O₃) weight ratio of 0.1 and 690 g of silica sand having an average particle size of 250 μm and the CaO/(SiO₂+Al₂O₃) weight ratio of less than 0.1, and 210 g of a molten material prepared by re-heating the modified sulfur (A) into a molten state were introduced substantially simultaneously into a mixer maintained at 140° C. The materials were kneaded for 10 minutes, and poured into a columnar mold of 5 cm in diameter and 10 cm in height, and cooled to obtain specimen (A).

### Example 2

Specimen (B) was prepared in the same way as in Example 1, except that the aggregate was replaced with an aggregate consisting of 780 g of silica sand having an average particle size of 250 μm and the CaO/(SiO₂+Al₂O₃) weight ratio of less than 0.1.

### Example 3

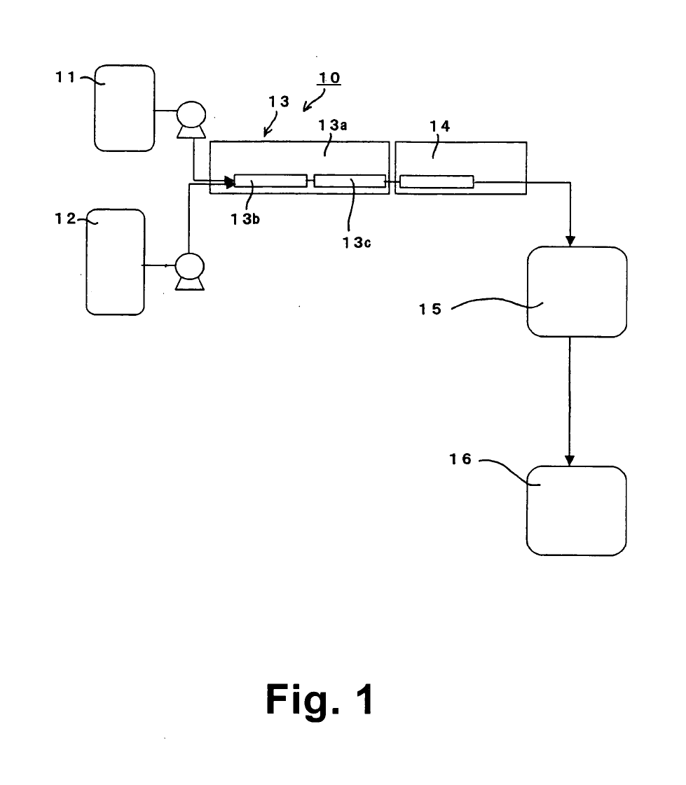

Using system 10 for producing a material containing modified sulfur as shown FIG. 1, a material was prepared. The production system 10 includes tanks 11 and 12, static mixer 13 consisting of stirring tube 13b and holding tube 13c both disposed in a heat reserving chamber 13a, cooling tank 14, storage tank 15, and batch mixer 16.

Sulfur, which was melted in the tank 11 maintained at 140° C. and supplied therefrom at the flow rate of 660 g/min by a fixed delivery pump, and dicyclopentadiene, which was melted in the tank 12 maintained at 140° C. and supplied therefrom at the flow rate of 35 g/min, were introduced into the stirring tube 13b (length 10 cm, inner diameter 11.0 mm, with 17 elements) of the static mixer 13 maintained at 150° C. at the liquid linear velocity of 0.4 m/min, and the two materials were stirred in the stirring tube 13b to continuously generate reaction precursors. The mixture was passed through the holding tube 13c maintained at 150° C. over 5-minute residence time, and then through the cooling tank 14 of a static mixer type (length 18 cm, inner diameter 11.0 mm, with 24 elements) maintained at 130° C. to immediately cool the mixture to 130° C., to thereby prepare a molten modified sulfur having a viscosity of 1 Pa·s at 140° C., an average particle size of 450 measured by GPC, and a molecular weight distribution of 200 to 2000. The molten material was temporarily stored in the storage tank 15 maintained at 130° C. It was demonstrated that the production system 10 was capable of producing 42 kg/hr of the modified sulfur.

Next, 21 kg of the molten modified sulfur stored in the storage tank 15 was introduced into the mixer 16 maintained at 140° C., and simultaneously an aggregate pre-heated to 140° C. consisting of 69 kg of silica sand having an average particle size of 250 μm and the CaO/(SiO₂+Al₂O₃) weight ratio of less than 0.1 and 10 kg of coal ash having an average particle size of 50 μm and the CaO/(SiO₂+Al₂O₃) weight ratio of 0.1 was also introduced into the mixer 16. The materials were kneaded for 10 minutes, poured into a columnar mold of 5 cm in diameter and 10 cm in height, and cooled to obtain specimen (C).

### Comparative Example 1

12.44 kg of normal Portland cement (manufactured by HITACHI CEMENT CO.), 31.42 kg of sand having particle sizes of not larger than 5 mm (from Kimitsu, Chiba, Japan), 34.41 kg of gravel having particle sizes of not larger than 5 mm (from Otsuki, Yamanashi, Japan), and 5.72 kg of water were kneaded in a concrete mixer, and cast in a columnar mold of 5 cm in diameter and 10 cm in height. After the mixture was set, the product was demolded, and cured in water for 28 days, to thereby obtain specimen (D).

### Comparative Example 2

Specimen (E) was prepared in the same way as in Example 1, except that the aggregate was replaced with an aggregate consisting of 780 g of blast furnace slag having particle sizes of not larger than 10 mm, and the CaO/(SiO₂+Al₂O₃) weight ratio of 0.9.

### Example 4

Specimen (F) was prepared in the same way as in Example 1, except that the aggregate was replaced with an aggregate consisting of 780 g of quartz powders having an average particle size of 250 μm and the CaO/(SiO₂+Al₂O₃) weight ratio of 0.

TABLE 1

| | Example | Example | Example | Example | Comp. Ex. | Comp. Ex. |
|---|---|---|---|---|---|---|
| | 1 | 2 | 3 | 4 | 1 | 2 |
| Kind of | Specimen | Specimen | Specimen | Specimen | Specimen | Specimen |
| Specimen | (A) | (B) | (C) | (F) | (D) | (E) |
| Appearance | No | No | No | No | Corroded | Slightly |
| | change | Change | change | change | | Corroded, |
| | | | | | | Swollen |
| Weight | 0 | 0 | 0 | 0 | −62 | +8 |
| Change (%) | | | | | | |
| Initial | 59.8 | 51.7 | 62.9 | 51.7 | 35.2 | 65.8 |
| Strength | | | | | | |
| (MN/m²) | | | | | | |
| Strength | 1.2 | 3.9 | 0.9 | 3.9 | 100 | 13.2 |
| Loss (%) | | | | | | |

TABLE 2

| | Example | Example | Example | Example | Comp. Ex. | Comp. Ex. |
|---|---|---|---|---|---|---|
| | 1 | 2 | 3 | 4 | 1 | 2 |
| Kind of | Specimen | Specimen | Specimen | Specimen | Specimen | Specimen |
| Specimen | (A) | (B) | (C) | (F) | (D) | (E) |
| Appearance | No | No | No | No | Corroded | Slightly |
| | change | Change | change | change | | Corroded, |
| | | | | | | Swollen |
| Weight | 0 | 0 | 0 | 0 | −27 | +2 |
| Change (%) | | | | | | |
| Initial | 59.6 | 51.3 | 63.2 | 51.3 | 35.0 | 65.8 |
| Strength | | | | | | |
| (MN/m²) | | | | | | |
| Strength | 0.9 | 3.2 | 0.4 | 3.2 | 100 | 6.7 |
| Loss (%) | | | | | | |

From Tables 1 and 2 as well as FIGS. 2 and 3, it is understood that the specimens (A) to (C) and (F) prepared in Examples 1 to 3 maintained the original state prior to the test even after the soaking for 6 months, while the specimen (D) prepared using the normal concrete in Comparative Example 1 was significantly corroded to loose its original shape. The specimen (E) prepared in Comparative Example 2 using the blast furnace slag having the CaO/(SiO₂+Al₂O₃) weight ratio of 0.9 as the aggregate was observed to be corroded on its surface in the presence of sulfuric acid. Thus it was understood that the specimens (A) to (C) and (F) prepared in Examples 1 to 4 underwent little change in appearance and weight, and small compression strength loss, and exhibited extremely high resistance to an aqueous solution of acid.

TABLE 3

| | Example | Example | Example | Example | Comp. Ex. |
|---|---|---|---|---|---|
| | 1 | 2 | 3 | 4 | 1 |
| Kind of | Specimen | Specimen | Specimen | Specimen | Specimen |
| Specimen | (A) | (B) | (C) | (F) | (D) |
| Appearance | No | No | No | No | Corroded |
| | change | Change | change | change | |
| Weight | 0 | 0 | 0 | 0 | −49 |
| Change (%) | | | | | |

From Table 3 and FIG. 4, it is understood that the specimens (A) to (C) and (F) prepared in Examples 1 to 4 underwent little change in appearance and weight, and exhibited high resistance to the sulfur-oxidizing bacteria. Through the same evaluation, the specimen (D) prepared in Comparative Example 1 using the normal concrete was confirmed to be corroded significantly in the habitat of the sulfur-oxidizing bacteria.

TABLE 4

| | Example | Example | Example | Example | Comp. Ex. |
|---|---|---|---|---|---|
| | 1 | 2 | 3 | 4 | 1 |
| Kind of | Specimen | Specimen | Specimen | Specimen | Specimen |
| Specimen | (A) | (B) | (C) | (F) | (D) |
| Appearance | No | No | No | No | Corroded |
| | change | Change | change | change | |
| Weight | 0 | 0 | 0 | 0 | −62 |
| Change (%) | | | | | |
| Initial | 59.9 | 51.6 | 63.7 | 51.6 | 35.4 |
| Strength | | | | | |
| (MN/m²) | | | | | |
| Strength | 0.3 | 1.1 | 0.1 | 1.1 | 100 |
| Loss (%) | | | | | |

From Table 4 and FIG. 5, it is understood that the specimens (A) to (C) and (F) prepared in Examples 1 to 4 underwent little change in appearance and weight, and small compression strength loss during the twelve-month evaluation, and exhibited extremely high corrosion resistance under the concrete-corroding environment such as in sewerage or wastewater treatment sites, compared to the specimen (D) prepared in Comparative Example 1 using the normal concrete.

1. An acid-resistant sulfur material comprising a modified sulfur and an aggregate, said modified sulfur having been prepared by polymerizing sulfur with a sulfur modifier,
wherein said aggregate is an inorganic aggregate comprising at least Si, and
wherein a weight ratio of Ca, Si, and Al in the aggregate in terms of oxides expressed as CaO/(SiO₂+Al₂O₃) is not higher than 0.2.

2. The acid-resistant sulfur material of claim 1, wherein a ratio of said modified sulfur to said aggregate in the sulfur material is 1 to 5:5 to 9 by weight.

3. The acid-resistant sulfur material of claim 1, wherein said aggregate comprises one or more members selected from the group consisting of coal ash, silica sand, silica, quartz powders, gravel, sand, clay minerals, and glass powders.

4. The acid-resistant sulfur material of claim 1, wherein said aggregate comprises not less than 5 wt % of an aggregate having an average particle size of not larger than 100 μm.

5. The acid-resistant sulfur material of claim 1 further comprising one or more members selected from the group consisting of fiber filling, fibrous particles, flake particles, and mixtures thereof.

6. A method of constructing an acid-resistant sulfur material, comprising the steps of:
producing a civil engineering or construction product with an acid-resistant sulfur material of claim 1, and
placing said product in an environment of not higher than pH 3.5.

7. The method of claim 6, wherein said civil engineering or construction product is a Hume pipe, manhole, box culvert, tile, block, or panel.
